(19) United States
(12) Patent Application Publication
(10) Pub. No.: US 2024/0127480 A1
(43) Pub. Date: Apr. 18, 2024

(54) INFORMATION PROCESSING APPARATUS, INFORMATION PROCESSING METHOD, AND PROGRAM

(71) Applicant: NEC Corporation, Tokyo (JP)

(72) Inventor: Jiro ABE, Tokyo (JP)

(73) Assignee: NEC Corporation, Tokyo (JP)

(21) Appl. No.: 18/376,056

(22) Filed: Oct. 3, 2023

(30) Foreign Application Priority Data
Oct. 14, 2022 (JP) 2022-165151

(51) Int. Cl. G06T 7/80; G06V 10/44

(52) U.S. Cl. CPC G06T 7/80; G06V 10/443; G06T 2207/10028; G06T 2207/30201; G06T 2207/30242; G06T 2207/30244

(57) ABSTRACT

An information processing apparatus includes: at least one memory configured to store instructions; and at least one processor configured to execute the instructions to: generate a virtual camera image shot by a virtual camera in a specific location and orientation in a three-dimensional space on the basis of point cloud data of the three-dimensional space; and estimate, on the basis of the virtual camera image, a camera image shot by a camera, and the point cloud data, a location of the camera when it shot the camera image from a location in the same space as the specific location in the three-dimensional space.

### INCORPORATION BY REFERENCE

This application is based upon and claims the benefit of priority from Japanese patent application No. 2022-165151, filed on Oct. 14, 2022, the disclosure of which is incorporated herein in its entirety by reference.

### TECHNICAL FIELD

The present disclosure relates to an information processing apparatus, an information processing method, and a program.

### BACKGROUND ART

Japanese Unexamined Patent Application Publication No. 2018-200504 discloses a technique for obtaining a set of three-dimensional coordinates of three-dimensional points on at least one object included in three-dimensional point cloud data, obtaining, from an input image, a set of coordinates representing the end points of edges included in the input image, and modifying information on the location and orientation of a camera using the set of three-dimensional coordinates and the set of coordinates representing the end points of edges, thereby estimating the location and orientation of the camera when it shot the input image.

However, the technique described in Japanese Unexamined Patent Application Publication No. 2018-200504 has such a problem that the process of estimating the location and orientation of a camera when an image was shot is relatively time-consuming.

In view of the above-mentioned problem, an object of the present disclosure is to provide a technique capable of more appropriately estimating the location and orientation of a camera when it shot an image.

### SUMMARY

According to a first example aspect of the present disclosure, an information processing apparatus includes:
at least one memory configured to store instructions; and
at least one processor configured to execute the instructions to:
   generate a virtual camera image shot by a virtual camera in a specific location and orientation in a three-dimensional space on the basis of point cloud data of the three-dimensional space; and
   estimate, on the basis of the virtual camera image, a camera image shot by a camera, and the point cloud data, a location of the camera when it shot the camera image from a location in the same space as the specific location in the three-dimensional space.

According to a second aspect of the present disclosure, an information processing method includes:
generating a virtual camera image shot by a virtual camera in a specific location and orientation in a three-dimensional space on the basis of point cloud data of the three-dimensional space; and
estimating, on the basis of the virtual camera image, a camera image shot by a camera, and the point cloud data, a location of the camera when it shot the camera image from a location in the same space as the specific location in the three-dimensional space.

According to a third aspect of the present disclosure, a non-transitory computer readable medium stores a program for causing a computer to execute processes of:
generating a virtual camera image shot by a virtual camera in a specific location and orientation in a three-dimensional space on the basis of point cloud data of the three-dimensional space; and
estimating, on the basis of the virtual camera image, a camera image shot by a camera, and the point cloud data, a location of the camera when it shot the camera image from a location in the same space as the specific location in the three-dimensional space.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram showing an example of a configuration of an information processing apparatus according to an example embodiment;

FIG. 2 is a diagram showing an example of a hardware configuration of an information processing apparatus according to an example embodiment;

FIG. 3 is a flowchart showing an example of a process for generating a virtual camera image with an information processing apparatus according to an example embodiment;

FIG. 4 is a diagram showing an example of information stored in a point cloud data DB (database) according to an example embodiment;

FIG. 5 is a diagram showing an example of point cloud data according to an example embodiment;

FIG. 6 is a diagram showing an example of a human-accessible area according to an example embodiment;

FIG. 7 is a diagram showing an example of a virtual camera image according to an example embodiment;

FIG. 8 is a diagram showing an example of a virtual camera image according to an example embodiment;

FIG. 9 shows an example of a virtual camera image according to an example embodiment;

FIG. 10 shows an example of information stored in a virtual camera image DB according to an example embodiment;

FIG. 11 is a flowchart showing an example of a process of estimating a shooting location and orientation of an information processing apparatus according to an example embodiment when it shot a camera image;

FIG. 12 is a diagram showing an example of a camera image according to an example embodiment; and

FIG. 13 is a diagram showing an example of an initial location or a location contained in the same space as the feature points in a virtual camera image.

### EXAMPLE EMBODIMENT

The principles of the present disclosure will be described with reference to some exemplary example embodiments. It should be understood that these example embodiments are described for illustrative purposes only and will assist those skilled in the art in understanding and implementing the present disclosure without suggesting any limitations with respect to the scope of the present disclosure. The disclosure described herein may be implemented in a variety of ways other than those described below.

In the following description and claims, unless otherwise defined, all technical and scientific terms used herein have the same meanings as are generally understood by those skilled in the art to which the present disclosure belongs.

Hereinafter, example embodiments of the present disclosure will be described with reference to the drawings.

### First Example Embodiment

### <Configuration>

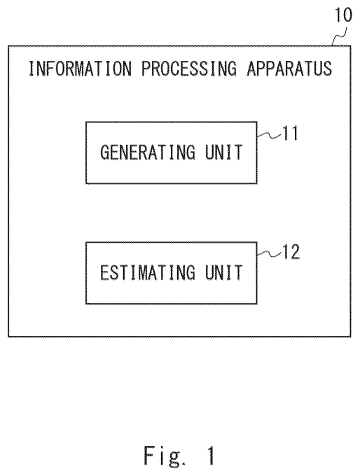

Referring to FIG. 1, a configuration of an information processing apparatus 10 according to an example embodiment will be described. FIG. 1 is a diagram showing an example of the configuration of the information processing apparatus 10 according to an example embodiment. The information processing apparatus 10 includes a generating unit 11 and an estimating unit 12. These components may be implemented by collaborative operation of one or more programs installed in the information processing apparatus 10 and hardware such as a processor and a memory of the information processing apparatus 10.

The generating unit 11 generates a virtual camera image shot by a virtual camera in a specific location and orientation in a three-dimensional space on the basis of the point cloud data of the three-dimensional space. On the basis of the virtual camera image, the camera image shot by the camera, and the point cloud data, the estimating unit 12 estimates the location of the camera when it shot the camera image from a location in the same space as the specific location in the three-dimensional space indicated by the point cloud data.

### Second Example Embodiment

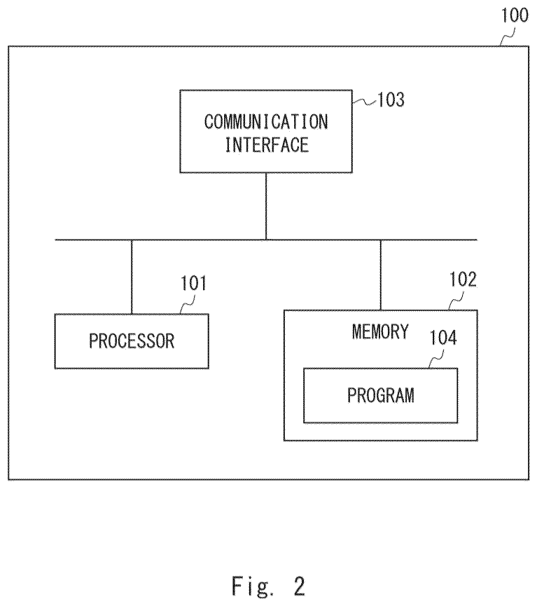

Next, with reference to FIG. 2, the configuration of the information processing apparatus 10 according to an example embodiment will be described.

### <Hardware Configuration>

FIG. 2 is a diagram showing an example of a hardware configuration of the information processing apparatus 10 according to an example embodiment. In the example illustrated in FIG. 2, the information processing apparatus 10 (a computer 100) includes a processor 101, a memory 102, and a communication interface 103. These components may be mutually connected via a bus or the like. The memory 102 stores at least a part of a program 104. The communication interface 103 includes an interface required for communication with other network elements.

When the program 104 is executed collaboratively with the processor 101, the memory 102, and the like, the computer 100 performs at least a part of the processing according to an example embodiment of the present disclosure. The memory 102 may be of any type. The memory 102 may be a non-temporary computer readable storage medium as a non-limiting example. The memory 102 may also be implemented using any suitable data storage techniques such as semiconductor-based memory devices, magnetic memory devices and systems, optical memory devices and systems, and fixed and removable memories. While the computer 100 shown in FIG. 2 includes only one memory 102, the computer 100 may have several physically distinct memory modules. The processor 101 may be of any type. The processor 101 may include at least one of a general purpose computer, a dedicated computer, a microprocessor, a digital signal processor (DSP), and as a non-limiting example, a processor configured on the basis of a multi-core processor architecture. The computer 100 may include a plurality of processors such as an application-specific integrated circuit chip that is temporally dependent on a clock that synchronizes the main processor.

The example embodiments of the present disclosure may be implemented in hardware or dedicated circuits, software, logic or any combination thereof. Some aspects of the present disclosure may be implemented in hardware, while others may be implemented in firmware or software that may be executed by a controller, a microprocessor, or other computing devices.

The present disclosure also provides at least one computer program product that is tangibly stored in a non-temporary computer readable storage medium. The computer program product includes computer executable instructions, such as instructions contained in program modules, and is executed on a device on a real or a virtual target processor to thereby execute the process or the method of the present disclosure. Program modules include routines, programs, libraries, objects, classes, components, data structures, and the like that perform a specific task or implement a specific abstract data type. The functions of program modules may be combined or divided among the program modules as desired in various example embodiments. The machine executable instructions in program modules can be executed locally or within distributed devices. In a distributed device, program modules can be arranged on both local and remote storage media.

The program codes for implementing the method of the present disclosure may be written in any combination of one or more programming languages. These program codes may be provided to a processor or controller of a general-purpose computer, a dedicated computer, or other programmable data processing apparatus. When the program codes are executed by a processor or a controller, the implemented functions/operations in the flowcharts and/or the block diagrams are executed. The program codes are executed entirely on the machine, partly on the machine as a standalone software package, partly on the machine, partly on a remote machine, or entirely on a remote machine or a server.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

### <Processing>

### <<Processing for Generating Virtual Camera Image>>

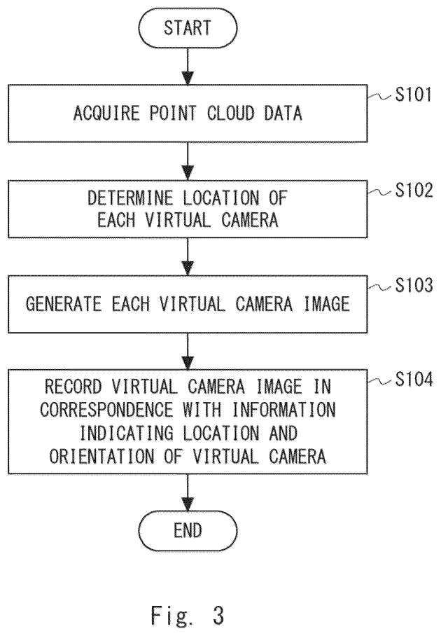

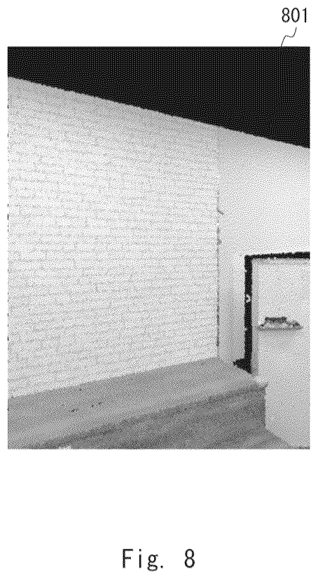

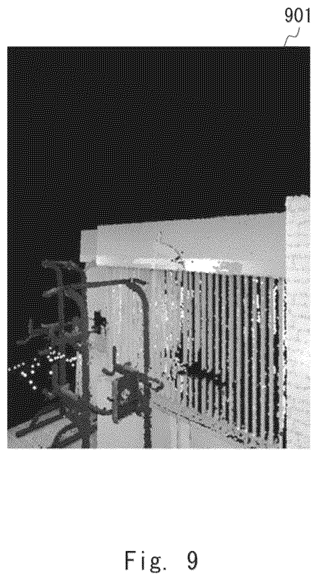

Next, with reference to FIGS. 3 to 10, an example of processing for generating a virtual camera image of the information processing apparatus 10 according to an example embodiment will be described. FIG. 3 is a flowchart showing an example of the processing for generating a virtual camera image of the information processing apparatus 10 according to an example embodiment. The processing shown in FIG. 3 may be executed when, for example, a predetermined operation is performed by an operator (an administrator) of the information processing apparatus 10. The order of the steps of the processing shown in FIG. 3 may be changed as appropriate as long as it does not cause any inconsistency. For example, the processing from Step S102 to Step S104 may be executed sequentially for each virtual camera.

In Step S101, the generating unit 11 acquires point cloud data of the three-dimensional space from a point cloud data DB 401. The point cloud data DB 401 may be stored in an internal memory of the information processing apparatus 10 or an external memory (e.g., a DB server). The information in the point cloud data DB 401 may be recorded in advance by an operator or the like of the information processing apparatus 10.

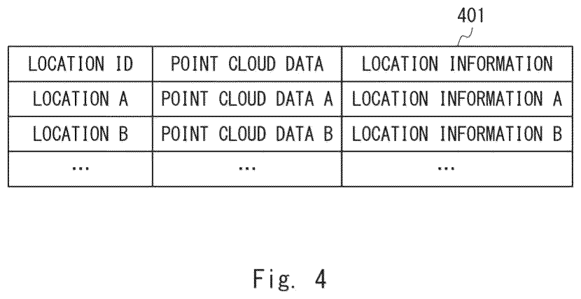

FIG. 4 is a diagram showing an example of information stored in a point cloud data DB (database) 401 according to an example embodiment. As shown in the example illustrated in FIG. 4, the point cloud data DB 401 stores point cloud data and the location information corresponding to the location ID. The location ID is information identifying the location (facility) where measurement (acquisition, measurement, generation) of the point cloud data was performed.

Point cloud data may be generated, for example, by at least one of a LiDAR (Light Detection And Ranging, Laser Imaging Detection And Ranging), a ToF (Time of Flight) camera, a stereo camera, and a 3D (Dimension) scanner. The point cloud data (point cloud) may be, for example, a set of point (observation point) data on the surface of an object in a three-dimensional space. Each point data may include a value indicating a location in, for example, a Cartesian coordinate system (x, y, z) or the like. Each point data may also include, for example, color and location information in a real space (latitude, longitude, altitude). The color of each point may be measured, for example, by a LiDAR equipped with a camera. The location information of each point in a real space may be calculated, for example, on the basis of the location information set by an operator or the like for each of a plurality of points included in the point cloud data.

Subsequently, the generating unit 11 determines the location of each of the plurality of virtual cameras in the three-dimensional space (Step S102). Here, the generating unit 11 may first perform downsampling of the point cloud data using a method such as FPS (Farthest Point Sampling) method.

Further, the generating unit 11 may recognize an area that is accessible to humans (hereinafter referred to as a human-accessible area) on the basis of the point cloud data and determine the location of the virtual camera on the basis of the recognized information. In this case, the generating unit 11 may detect an area such as the ground on the basis of the point cloud data using artificial intelligence (AI) or the like, and determine areas that are not blocked by objects or the like in the detected area such as the ground as the human-accessible areas. By the above configuration, it is possible to detect, for example, a location that is relatively likely to be selected as a shooting location where a maintenance staff performs shooting. Then, the generating unit 11 may determine a location in the human-accessible area as a horizontal location (latitude, longitude) of the virtual camera. For example, the generating unit 11 may determine a location at a specific height (e.g., 1.6 meters) from the altitude of the human-accessible area as a vertical location (altitude) of the virtual camera.

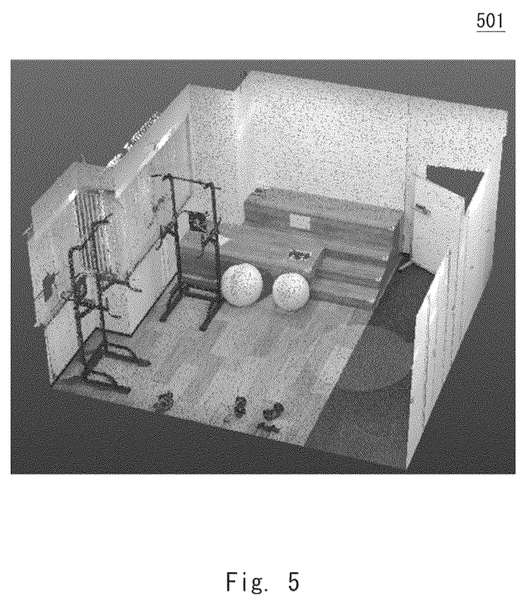

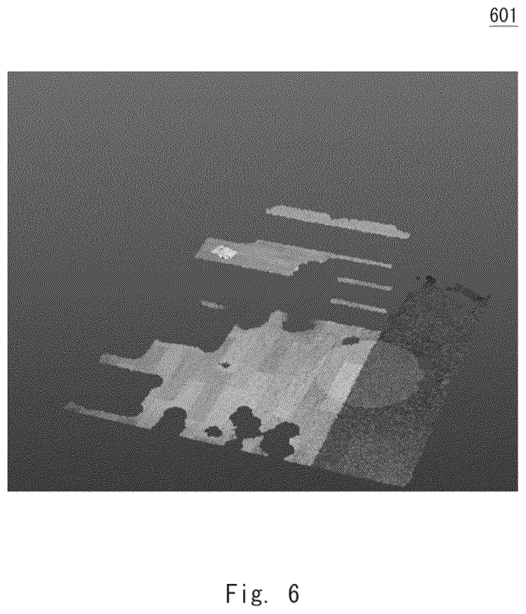

FIG. 5 is a diagram showing an example of point cloud data 501 according to an example embodiment. In the example illustrated in FIG. 5, a display example of the point cloud data 501 generated when a specific room is measured by LiDAR is shown. FIG. 6 is a diagram showing an example of a human-accessible area 601 according to an example embodiment. In the example illustrated in FIG. 6, an example of the human-accessible area 601 detected from the point cloud data 501 is shown. In the example illustrated in FIG. 6, a floor surface 611 in a specific room and a horizontal part 612 of a staircase are detected as human-accessible areas.

The generating unit 11 may also determine the location and orientation of the virtual camera on the basis of the normal direction of the face of the object identified on the basis of a plurality of points included in the point cloud data. In this case, on the basis of a specific point and the point cloud around the specific point the generating unit 11 may, for example, identify a face of an object including the specific point. Then, the generating unit 11 may, for example, determine the horizontal location of the virtual camera in the human-accessible area, which is at a certain distance from the specific point in the normal direction. The generating unit 11 may, for example, determine the orientation of the virtual camera so that the virtual camera changes the direction it faces from the direction opposite to the normal direction (the direction from the location of the virtual camera to the specific point) to a direction within a predetermined range. In this way, the location and orientation of the camera, which is considered relatively likely to be selected by the maintenance personnel when the maintenance personnel shoots the object including the specific point with the camera, can be determined as the location and orientation of the virtual camera.

In addition, the generating unit 11 may recognize at least one of area where an object of a specific type is present and the human-accessible area on the basis of the point cloud data and determine, on the basis of the aforementioned recognized information, at least one of the location and orientation of the virtual camera. In this case, the generating unit 11 may identify the type of the object indicated by each point in the point cloud data on the basis of, for example, AI using deep learning or the like. The generating unit 11 may determine, for example, an object of a specific type such as a bridge, an outer wall, a power generation facility, or the like as the specific object. Thus, it is possible to detect, for example, an object which is considered relatively likely to be selected as a subject to be shot by a maintenance staff. The generating unit 11 may then determine, as the location and orientation of the virtual camera, the location and orientation of the virtual camera which is capable of shooting at least a part of the object of the specific type from a human-accessible area.

### (Example of Determining Location and Orientation of Virtual Camera on the Basis of Camera Image Shot in the Past)

The generating unit 11 may determine the location and orientation of the virtual camera on the basis of the camera image shot in the past. Thus, for example, the location and orientation of the camera, which is considered relatively likely to be used by a maintenance personnel when shooting an image in the future, can be set as the location and orientation of the virtual camera. In this case, the generating unit 11 may determine the location and orientation of the virtual camera on the basis of the location and orientation of the camera when it shot the first camera image (the camera image shot in the past) estimated by the estimating unit 12.

Subsequently, the generating unit 11 generates images (virtual camera images, projected images) of the three-dimensional space shot by each virtual camera (Step S103). Here, the generating unit 11 generates (performs rendering of) a virtual camera image on the basis of the point cloud data, the location and orientation of the virtual camera, and the shooting settings of each virtual camera. The settings related to shooting by the virtual camera may include, for example, information such as the angle of view and focal length (zoom) of the virtual camera.

In this case, for example, when each point included in the point cloud data is a sphere or the like having a specific size, the generating unit 11 may generate data as a virtual camera image that projects each point nearest to it in each direction as viewed from the virtual camera.

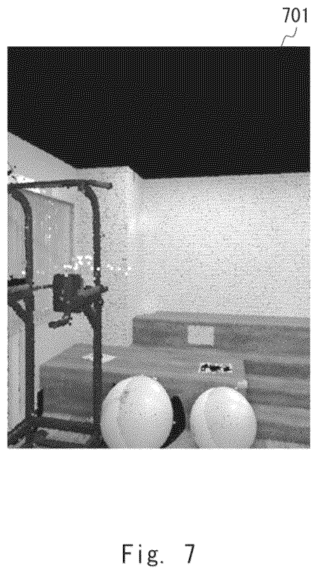

FIGS. 7 to 9 are diagrams showing an example of a virtual camera image according to an example embodiment. FIGS. 7 to 9 show an example of virtual camera images 701, 801, and 901, respectively, generated on the basis of the point cloud data 501 shown in FIG. 5.

Subsequently, for each virtual camera image, the generating unit 11 records the virtual camera image in correspondence (association) with the information indicating the location and orientation of the virtual camera in the three-dimensional space in a virtual camera image DB 501 (Step S104). The virtual camera image DB 501 may be stored in an internal memory of the information processing apparatus 10 or stored in an external memory (e.g., a DB server).

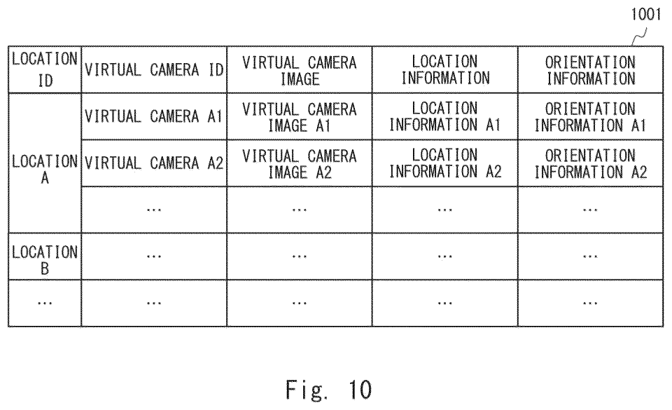

FIG. 10 is a diagram showing an example of information stored in a virtual camera image DB 1001 according to an example embodiment. In the example illustrated in FIG. 10, a virtual camera image, location information, and orientation information are recorded in the virtual camera image DB 1001 in correspondence with a combination of the location ID and the virtual camera ID. The location information is information indicating the location of the virtual camera in a three-dimensional space. The orientation information is information indicating the orientation of the virtual camera in a three-dimensional space. The orientation information may include, for example, information on a roll angle, a pitch angle, and a yaw angle of the camera in the three-dimensional space.

### <<Process for Estimating Shooting Location and Orientation of Camera Image>>

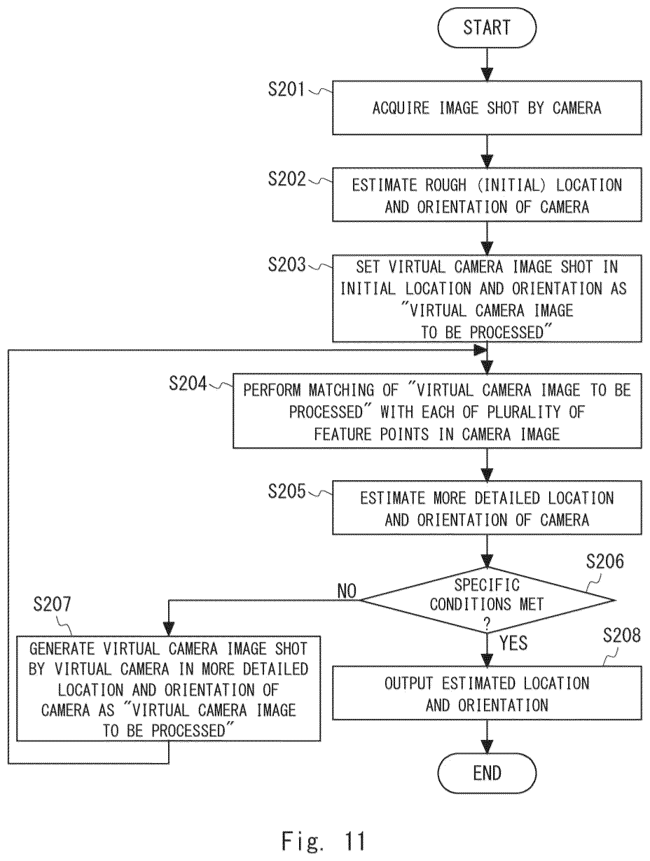

Next, with reference to FIGS. 11 to 14, an example of processing for estimating the shooting location and orientation of the information processing apparatus 10 according to an example embodiment when it shot a camera image will be described. FIG. 11 is a flowchart showing an example of processing for estimating the shooting location and orientation of the information processing apparatus 10 according to an example embodiment when it shot a camera image. The processing shown in FIG. 11 may be executed when, for example, a predetermined operation is performed by an operator (administrator) of the information processing apparatus 10. It should be noted that the order steps of the processing shown in FIG. 11 may be changed as appropriate as long as it does not cause any inconsistency.

In Step S201, the estimating unit 12 acquires (inputs) images (camera images, query images) shot by the camera. Here, the estimating unit 12 may acquire, for example, a camera image and a location ID designated by an operator or the like.

Subsequently, the estimating unit 12 estimates rough location and orientation (initial location and orientation; an example of “first location and orientation”) of the camera when the camera image was shot (Step S202). Here, the estimating unit 12 may calculate the degree of similarity between each virtual camera image and the camera image on the basis of, for example, the local features of each virtual camera image recorded in the virtual camera image DB 1001 in correspondence with the location ID and the local features of the camera image. In this case, the estimating unit 12 may calculate the degree of similarity by, for example, comparing VLAD (Vector of Locally Aggregated Descriptors) that can represent the global feature amounts by aggregating the differences between each local feature amount and the corresponding basis vector. The estimating unit 12 may, for example, perform local feature matching between the virtual camera images and the camera image, and calculate the degree of similarity between each virtual camera image and the camera image on the basis of the number of matches, the sum of scores, and the like.

Then, the estimating unit 12 may estimate the location and orientation of the virtual camera which shot the virtual camera image having the highest degree of similarity with the camera image among the plurality of virtual camera images generated by the generating unit 11 as the rough location and orientation of the virtual camera.

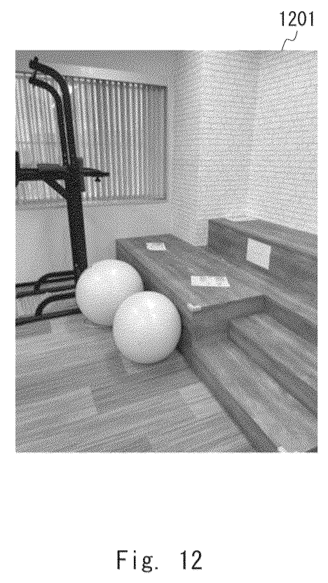

FIG. 12 is a diagram showing an example of a camera image 1201 according to an example embodiment. When the camera image shown in FIG. 12 is input, the location and orientation of the virtual camera which shot the virtual camera image 701 having the highest similarity with the camera image among the virtual camera images 701, 801, and 901 shown in FIGS. 7 to 9 are estimated as being the rough location and orientation of the camera.

Subsequently, the estimating unit 12 sets a virtual camera image shot in the initial location and orientation as the “virtual camera image to be processed” (Step S203). Thus, for example, among the plurality of virtual camera images recorded in the virtual camera image DB 1001, a virtual camera image having the highest degree of similarity with the camera image is selected as the “virtual camera image to be processed”.

Subsequently, the estimating unit 12 performs matching of each of the plurality of feature points in the “virtual camera image to be processed” with a corresponding one of each of the plurality of feature points in the camera image (Step S204). Here, the estimating unit 12 may, for example, extract a plurality of feature points from each of the two images and perform matching of the similar feature points in the two images. The estimating unit 12 may detect the feature points from each image using, for example, SIFT (Scale-Invariant Feature Transform), SURF Speeded-Up Robust Features), AKAZE (Accelerated-KAZE), or the like.

Subsequently, on the basis of the locations of the plurality of feature points in the virtual camera image of the three-dimensional space, the estimating unit 12 estimates a more detailed (i.e., highly precise) location and orientation (an example of “a second location and orientation”) of the camera when the camera image was shot (Step S205). Here, the estimating unit 12 may first calculate a plurality of candidates for the more detailed camera location and orientation by, for example, solving a known PnP (Perspective-n-Point) problem. In this case, the estimating unit 12 may, for example, select a plurality of combinations of the plurality of feature points matched in the two images. The estimating unit 12 may, for example, calculate one or more candidates for the location and orientation of the camera from each of the above combinations (one or more candidates from each combination) by solving simultaneous equations of the PnP problem for each combination of the three or more feature points.

### (Example of Estimating Location in the Same Space as Initial Location as More Detailed Camera Location)

The estimating unit 12 may, for example, estimate the location in the same space as the initial location described above as a more detailed location of the camera. Due to this configuration, in, for example, an application where it is important that the estimated location of the camera in the output estimation result be in the same space as the true location, a more appropriate estimation result can be provided. The application may include, for example, an application for detecting the location of a robot moving around a factory or a house on the basis of a camera image of a monocular camera mounted on the robot and the point cloud data stored in advance. In this case, for example, due to a difference between the point cloud data stored in advance and the real space where the camera image was shot, or due to an error in the calibration of the camera or the like, it is possible to reduce a malfunction such as the robot movement being stopped due a detection error made based on the point cloud data that the robot is on the other side of a wall.

In this case, the estimating unit 12 may exclude a candidate whose location is not included in the same space as the initial location from each candidate calculated by solving the PnP problem for each combination. The estimating unit 12 may select, for example, a candidate for the location and orientation having the minimum reprojection error among the remaining candidates as the more detailed location and orientation of the camera.

In this case, the estimating unit 12 may determine, for example, that the location of a target to be determined is a location in the same space as the initial location in the case where there are even number (0, 2, 4, . . . ) of faces of the object detected on the basis of the point cloud data between the initial location and the location of the target to be determined (“first location”).

Further, in the case where, for example, there are even number (0, 2, 4, . . . ) of faces of the object to be detected on the basis of the point cloud data of the three-dimensional space from the initial location of the camera to the location of the target to be determined (“first location”), the estimating unit 12 may determine that the location of the target to be determined is in the same space as the initial location.

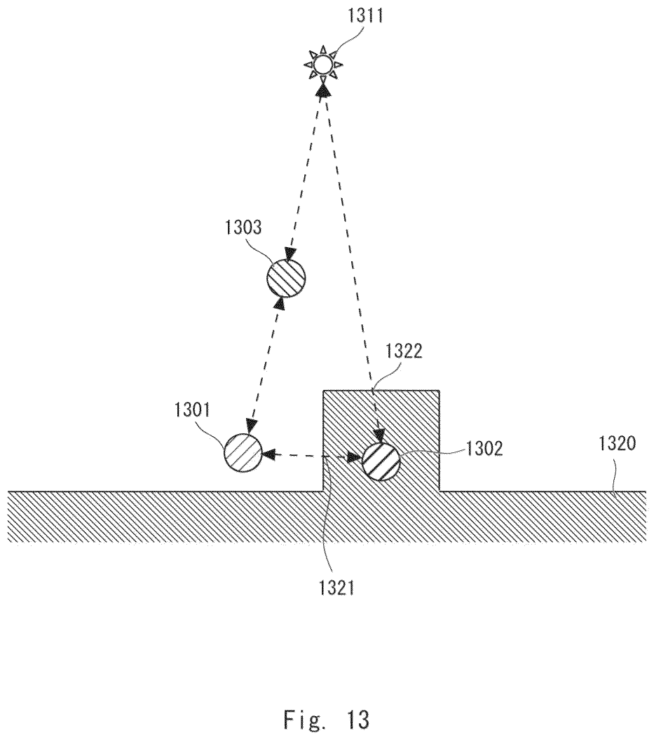

FIG. 13 is a diagram showing an example of an initial location according to example embodiment or a location in the same space as the feature points in a virtual camera image. FIG. 13 shows an example of an initial location 1301, a location 1311 of the feature points in a virtual camera image shot at the initial location, and a surface 1320 of an object (for example, a wall) on the basis of the point cloud data. In the example illustrated in FIG. 13, there is one (an odd number) point of intersection 1321 with the surface 1320 of the object on the line segment from the initial location 1301 to the location 1302. There is also one (an odd number) point of intersection 1322 with the surface 1320 of the object on the line segment from the location 1311 to the location 1302 in the three-dimensional space of the feature point. Therefore, it is determined that the location 1302 is not in the same space as the initial location 1301.

In the example illustrated in FIG. 13, there are even number (zero in this case; i.e., not present) of points of intersection with a surface 1320 of the object on the line segment from the initial location 1301 to the location 1303. There are also even number of points of intersection with the surface 1320 of the object on the line segment from the location 1311 to the location 1303 of the feature points in the virtual camera image of the three-dimensional space. Therefore, the location 1303 is determined to be a location in the same space as the initial location 1301.

Further, when, for example, the initial location and the location to be determined are present on the same side as seen from the face of the object to be detected on the basis of point cloud data, the estimating unit 12 may determine that the location to be determined is a location in the same space as the initial location. In this case, the estimating unit 12 may detect, for example, the face of the object located within a predetermined distance from the initial location and a predetermined distance from the location of the object to be determined on the basis of the point cloud data. The estimating unit 12 may determine, for example, that the initial location and the location to be determined are on the same side as viewed from the face of the target object to be determined when the direction from the surface of the object to the initial location and the direction from the surface of the object to the location of the object to be determined are within a predetermined range from the normal direction of the face of the object. The normal direction of the face of the object may be the direction on the sensor side of the LiDAR or the like when the point cloud data is measured as viewed from the face of the target object to be determined.

In addition, the estimating unit 12 may determine, for example, that the first location is in the same space as the specific location when the location of the feature points in the virtual camera image and the first location are present on the same side as viewed from the face of the object to be detected on the basis of point cloud data. In this case, the estimating unit 12 may detect, for example, the face of the object located within a predetermined distance from the location of the feature points in the three-dimensional space and the location of the object to be determined on the basis of the point cloud data. The estimating unit 12 may determine, for example, that when the direction from the face of the object to the location of the feature points in the three-dimensional space and the direction from the face of the object to the location of the object to be determined are within a predetermined range from the normal direction of the face of the object, the location of the feature points in the three-dimensional space and the location of the object to be determined are present on the same side as viewed from the face of the object to be determined. The normal direction of the face of the object may be the direction on the sensor side of the LiDAR or the like when point cloud data is measured as viewed from the face of the object to be detected.

Subsequently, the estimating unit 12 determines whether or not specific conditions are met (Step S206). Here, when the processing in Step S205 is repeated is a predetermined number of times, the estimating unit 12 may determine that the specific conditions are met.

When the degree of similarity between the “virtual camera image to be processed” and the camera image is equal to or greater than a predetermined threshold value, the estimating unit 12 may determine that the specific conditions are met. Thus, for example, the accuracy of the estimated location and orientation of the camera can be enhanced.

When the specific conditions are not met (NO in Step S206), the generating unit 11 generates a virtual camera image of the three-dimensional space shot by the virtual camera in a more detailed location and orientation of the camera as the “virtual camera image to be processed” (Step S207), and proceeds to the processing in Step S204. Note that the processing in Step S207 may be the same as the processing in Step S103 of FIG. 3 for generating a single virtual camera image.

On the other hand, when the specific conditions are met (YES in Step S206), the estimating unit 12 outputs the latest detailed information indicating the estimated location and orientation of the camera (Step S208). Thus, for example, an application for controlling the robot is notified of the estimated location and orientation of the camera.

### Modified Example

The information processing apparatus 10 may be an apparatus accommodated in one housing, but the information processing apparatus 10 of the present disclosure is not limited thereto. Each part of the information processing apparatus 10 may be implemented by, for example, a cloud computing system configured of one or more computers. Each of the above-described example embodiments can be combined as desired by one of ordinary skill in the art.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims. Each of the drawings or figures is merely an example to illustrate one or more example embodiments.

Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

According to one aspect, the location and orientation of the camera when it shot an image can be estimated more appropriately.

The whole or part of the exemplary embodiments disclosed above can be described as, but not limited to, the following supplementary notes.

### (Supplementary Note 1)

An information processing apparatus comprising:
at least one memory configured to store instructions; and
at least one processor configured to execute the instructions to: generate a virtual camera image shot by a virtual camera in a specific location and orientation in a three-dimensional space on the basis of point cloud data of the three-dimensional space; and
estimate, on the basis of the virtual camera image, a camera image shot by a camera, and the point cloud data, a location of the camera when it shot the camera image from a location in the same space as the specific location in the three-dimensional space.

### (Supplementary Note 2)

The information processing apparatus described in Supplementary note 1, wherein the instruction to estimate includes:
performing matching of each of the plurality of feature points in a first virtual camera image shot by a virtual camera at first location and orientation with each of the plurality of feature points in the camera image, and estimate second location and orientation of the camera when the camera image was shot on the basis of the location of each of the plurality of feature points in the first virtual camera image of the three-dimensional space; and
performing matching of each of the plurality of feature points in a second virtual camera image shot by a virtual camera at second location and orientation with each of the plurality of feature points in the camera image, and estimate third location and orientation of the camera when the camera image was shot on the basis of the location of each of the plurality of feature points in the second virtual camera image of the three-dimensional space.

### (Supplementary Note 3)

The information processing apparatus described in Supplementary note 1, wherein the instruction to estimate further includes:
estimating, when a degree of similarity between the second virtual camera image and the camera image is equal to or greater than a threshold value, the second location and orientation as the location and orientation of the camera when the camera image was taken; and
estimating, when a degree of similarity between the second virtual camera image and the camera image is not equal to or greater than a threshold value, the third location and orientation.

### (Supplementary Note 4)

The information processing apparatus described in Supplementary note 1, wherein the instruction to estimate further includes determining, when there are even number of faces of the object to be detected on the basis of the point cloud data between the specific location of the camera to the first location of the target to be determined that the first location is a location in the same three-dimensional space as the specific location.

### (Supplementary Note 5)

The information processing apparatus described in Supplementary note 1, wherein the instruction to estimate further includes determining, when there are even number of faces of the object detected on the basis of the point cloud data between the location in the three-dimensional space of the feature point in the virtual camera image and a first location, that the first location is a location in the same space as the specific location.

### (Supplementary Note 6)

The information processing apparatus described in Supplementary note 1, wherein the instruction to estimate further includes determining, when the specific location and a first location are present on the same side as viewed from the face of the object to be detected on the basis of the point cloud data, that, the first location is in the same space as the specific location.

### (Supplementary Note 7)

The information processing apparatus described in Supplementary note 1, wherein the instruction to estimate further includes determining, when the feature points in the virtual image of the three-dimensional space and a first location are present on the same side as viewed from the face of the object to be detected on the basis of the point cloud data, the first location is in the same space as the specific location.

### (Supplementary Note 8)

The information processing apparatus described in Supplementary note 1, wherein the cloud data is generated by at least one of a LiDAR (Light Detection And Ranging, Laser Imaging Detection And Ranging), a ToF (Time of Flight) camera, a stereo camera, and a 3D (Dimension) scanner.

### (Supplementary Note 9)

An image processing method comprising:
generating a virtual camera image shot by a virtual camera in a specific location and orientation in a three-dimensional space on the basis of point cloud data of the three-dimensional space; and
estimating, on the basis of the virtual camera image, a camera image shot by a camera, and the point cloud data, a location of the camera when it shot the camera image from a location in the same space as the specific location in the three-dimensional space.

### (Supplementary Note 10)

A non-transitory computer readable medium storing a program for causing a computer to execute processes of:
generating a virtual camera image shot by a virtual camera in a specific location and orientation in a three-dimensional space on the basis of point cloud data of the three-dimensional space; and
estimating, on the basis of the virtual camera image, a camera image shot by a camera, and the point cloud data, a location of the camera when it shot the camera image from a location in the same space as the specific location in the three-dimensional space.

What is claimed is:

1. An information processing apparatus comprising:
at least one memory configured to store instructions; and
at least one processor configured to execute the instructions to:
generate a virtual camera image shot by a virtual camera in a specific location and orientation in a three-dimensional space on the basis of point cloud data of the three-dimensional space; and
estimate, on the basis of the virtual camera image, a camera image shot by a camera, and the point cloud data, a location of the camera when it shot the camera image from a location in the same space as the specific location in the three-dimensional space.

2. The information processing apparatus according to claim 1, wherein the instruction to estimate includes:
performing matching of each of the plurality of feature points in a first virtual camera image shot by a virtual camera at a first location and orientation with a corresponding one of each of the plurality of feature points in the camera image, and estimate a second location and orientation of the camera when the camera image was shot on the basis of the location of each of the plurality of feature points in the first virtual camera image of the three-dimensional space; and
performing matching of each of the plurality of feature points in a second virtual camera image shot by a virtual camera at a second location and orientation with a corresponding one of each of the plurality of feature points in the camera image, and estimate a third location and orientation of the camera when the camera image was shot on the basis of the location of each of the plurality of feature points in the second virtual camera image of the three-dimensional space.

3. The information processing apparatus according to claim 2, wherein the instruction to estimate further includes:
estimating, when a degree of similarity between the second virtual camera image and the camera image is equal to or greater than a threshold value, the second location and orientation as the location and orientation of the camera when the camera image was taken; and
estimating, when a degree of similarity between the second virtual camera image and the camera image is not equal to or greater than a threshold value, the third location and orientation.

4. The information processing apparatus according to claim 1, wherein the instruction to estimate further includes determining, when there are an even number of faces of the object to be detected on the basis of the point cloud data between the specific location of the camera and the first location of the target to be determined that the first location is a location in the same three-dimensional space, as the specific location.

5. The information processing apparatus according to claim 1, wherein the instruction to estimate further includes determining, when there are an even number of faces of the object detected on the basis of the point cloud data between the location in the three-dimensional space of the feature point in the virtual camera image and a first location, that the first location is a location in the same space as the specific location.

6. The information processing apparatus according to claim 1, wherein the instruction to estimate further includes determining, when the specific location and a first location are present on the same side as viewed from the face of the object to be detected on the basis of the point cloud data, that the first location is in the same space as the specific location.

7. The information processing apparatus according to claim 1, wherein the instruction to estimate further includes determining, when the feature points in the virtual image of the three-dimensional space and a first location are present on the same side as viewed from the face of the object to be detected on the basis of the point cloud data, the first location is in the same space as the specific location.

8. The information processing apparatus according to claim 1, wherein the cloud data is generated by at least one of a LiDAR (Light Detection And Ranging, Laser Imaging Detection And Ranging), a ToF (Time of Flight) camera, a stereo camera, and a 3D (Dimension) scanner.

9. An image processing method comprising:
generating a virtual camera image shot by a virtual camera in a specific location and orientation in a three-dimensional space on the basis of point cloud data of the three-dimensional space; and
estimating, on the basis of the virtual camera image, a camera image shot by a camera, and the point cloud data, a location of the camera when it shot the camera image from a location in the same space as the specific location in the three-dimensional space.

10. A non-transitory computer readable medium storing a program for causing a computer to execute processes of:
generating a virtual camera image shot by a virtual camera in a specific location and orientation in a three-dimensional space on the basis of point cloud data of the three-dimensional space; and
estimating, on the basis of the virtual camera image, a camera image shot by a camera, and the point cloud data, a location of the camera when it shot the camera image from a location in the same space as the specific location in the three-dimensional space.
